(19) United States
(12) Patent Application Publication
(10) Pub. No.: US 2026/0039186 A1
(43) Pub. Date: Feb. 5, 2026

(54) DRIVING CIRCUIT AND DRIVING METHOD THEREOF CAPABLE OF QUICKLY SHUTTING DOWN SYNCHRONOUS RECTIFICATION TRANSISTOR

(71) Applicant: Richtek Technology Corporation, Zhubei City (TW)

(72) Inventors: Yu-Meng LIN, Tainan City (TW); Chien-Hung CHEN, Hsinchu City (TW); Chien-Fu TANG, Hsinchu City (TW); Tzu-Chen LIN, Zhubei City (TW)

(21) Appl. No.: 19/252,168

(22) Filed: Jun. 27, 2025

Related U.S. Application Data
(60) Provisional application No. 63/676,925, filed on Jul. 30, 2024.

(30) Foreign Application Priority Data
Mar. 13, 2025 (TW) 114109343

(51) Int. Cl. H02M 1/08; H02M 3/335

(52) U.S. Cl. CPC H02M 1/08; H02M 3/33515

(57) ABSTRACT

A driving circuit for driving a synchronous rectification transistor includes a first comparator, a second comparator, a third comparator, and a gate driving circuit. When the voltage of the drain terminal of the synchronous rectification transistor is less than a first threshold, the first comparator enables a first comparison signal. When the voltage of the drain terminal is not less than a second threshold, the second comparator enables a second comparison signal. When the voltage of the drain terminal is not less than a third threshold, the third comparator enables a third comparison signal. The gate driving circuit provides a gate voltage to a gate terminal of the synchronous rectification transistor based on the first comparison signal, the second comparison signal, and the third comparison signal.

### CROSS REFERENCE TO RELATED APPLICATIONS

This application claims the benefit of U.S. Provisional Application No. 63/676,925, filed on Jul. 30, 2024, the entirety of which is incorporated by reference herein.

This Application claims priority of Taiwan Patent Application No. 114109343, filed on Mar. 13, 2025, the entirety of which is incorporated by reference herein.

### BACKGROUND OF THE INVENTION

### Field of the Invention

The disclosure is generally related to a driving circuit and a driving method thereof having a synchronous rectification transistor, and more particularly it is related to a driving circuit and a driving method thereof capable of quickly shutting down a synchronous rectification transistor.

### Description of the Related Art

In traditional offline flyback conversion circuits, a diode is usually used as the rectification element on the secondary side to transfer energy to the output capacitor. However, in higher power applications, a diode may cause serious power loss and heat problems. To solve these problems, the diode can be replaced with a synchronous rectification transistor. Although a synchronous rectification transistor can improve conversion efficiency and thermal performance, the synchronous rectification control method is extremely challenging in isolated topologies because the signal on the primary side cannot be directly transmitted to the synchronous rectification controller.

### BRIEF SUMMARY OF THE INVENTION

The present invention proposes a driving circuit and a driving method capable of quickly turning off a synchronous rectification transistor, using a plurality of comparators to determine the voltage between the drain terminal and the source terminal of the synchronous rectification transistor, thereby gradually reducing the voltage between the gate terminal and the source terminal of the synchronous rectification transistor to reduce the charge required to be removed when turning off the synchronous rectification transistor. In addition, by using multiple comparators to gradually reduce the voltage between the gate terminal and the source terminal of the synchronous rectification transistor, there is no need to consider the stability problem, which significantly reduces the design complexity.

In an embodiment, a driving circuit for driving a synchronous rectification transistor is provided, which comprises a first comparator, a second comparator, a third comparator, and a gate driving circuit. When the voltage of a drain terminal of the synchronous rectification transistor is less than a first threshold, the first comparator enables a first comparison signal. When the voltage of the drain terminal of the synchronous rectification transistor is not less than a second threshold, the second comparator enables a second comparison signal. When the voltage of the drain terminal of the synchronous rectification transistor is not less than a third threshold, the third comparator enables a third comparison signal. The gate driving circuit provides a gate voltage to a gate terminal of the synchronous rectification transistor based on the first comparison signal, the second comparison signal, and the third comparison signal. The gate driving circuit turns on the synchronous rectification transistor based on the first comparison signal being enabled. The gate driving circuit turns off the synchronous rectification transistor based on the second comparison signal being enabled. The gate driving circuit increases the on-resistance of the synchronous rectification transistor based on the third comparison signal being enabled.

According to an embodiment of the present invention, the driving circuit further comprises a flip-flop. The flip-flop comprises a setting terminal, a reset terminal, and an output terminal. The setting terminal receives the first comparison signal, the reset terminal receives the second comparison signal, and the output terminal outputs an enable signal. The gate driving circuit further turns on or off the synchronous transistor based on the enable signal.

According to an embodiment of the present invention, the first threshold, the second threshold, and the third threshold are less than zero.

According to an embodiment of the present invention, the second threshold exceeds the third threshold. The third threshold exceeds the first threshold.

According to an embodiment of the present invention, the driving circuit further comprises a voltage adjustment device. The voltage adjustment device adjusts the gate voltage based on the third comparison signal. The gate driving circuit provides the gate voltage to the gate terminal, so as to increase the on-resistance of the synchronous rectification transistor.

According to an embodiment of the present invention, when the voltage of the drain terminal is less than a fourth threshold, the third comparator disables the third comparison signal.

According to an embodiment of the present invention, the voltage adjustment device decreases the gate voltage based on the third comparison signal being enabled. The voltage adjustment device maintains the gate voltage based on the third comparison signal being disabled.

According to an embodiment of the present invention, the driving circuit further comprises a fourth comparator. When the voltage of the drain terminal is less than a fourth threshold, the fourth comparator enables a fourth comparison signal.

According to an embodiment of the present invention, the voltage adjustment device decreases the gate voltage based on the third comparison signal being enabled. The voltage adjustment device maintains the gate voltage based on the fourth comparison signal being enabled.

According to an embodiment of the present invention, the fourth threshold is less than zero. The third threshold exceeds the fourth threshold. The fourth threshold exceeds the first threshold.

According to an embodiment of the present invention, the synchronous rectification transistor is an N-type transistor. The gate voltage is decreased to increase the on-resistance of the synchronous rectification transistor.

According to another embodiment of the present invention, the synchronous rectification transistor is a P-type transistor. The gate voltage is increased to increase the on-resistance of the synchronous rectification transistor.

According to an embodiment of the present invention, the synchronous rectification transistor is adapted to a synchronous flyback power conversion circuit.

In another embodiment, a driving method driving a synchronous rectification transistor is provided. The driving method comprises the following steps. A drain voltage from a drain terminal to a source terminal of the synchronous rectification transistor is detected. It is determined whether the drain voltage is less than a first threshold. When the drain voltage is less than the first threshold, the synchronous rectification transistor is turned on. When the synchronous rectification transistor is turned on, it is determined whether the drain voltage is less a second threshold. When the drain voltage is not less than the second threshold, the synchronous rectification transistor is turned off. When the synchronous rectification transistor is turned on, it is determined whether the drain voltage is less than a third threshold. When the drain voltage is not less than a third threshold, on-resistance of the synchronous rectification transistor is increased.

According to an embodiment of the present invention, the first threshold, the second threshold, and the third threshold are each less than zero.

According to an embodiment of the present invention, the second threshold exceeds the third threshold. The third threshold exceeds the first threshold.

According to an embodiment of the present invention, the driving method further comprises the following steps. After the step of increasing the on-resistance of the synchronous rectification transistor, it is determined whether the drain voltage is less than a fourth voltage. When the drain voltage is less than the fourth threshold, the on-resistance of the synchronous rectification transistor is maintained.

According to an embodiment of the present invention, the fourth threshold is less than zero. The third threshold exceeds the fourth threshold. The fourth threshold exceeds the first threshold.

According to an embodiment of the present invention, the synchronous rectification transistor is an N-type transistor. A gate voltage provided to a gate terminal of the synchronous rectification transistor is decreased to increase the on-resistance of the synchronous rectification transistor.

According to another embodiment of the present invention, the synchronous rectification transistor is a P-type transistor. A gate voltage provided to a gate terminal of the synchronous rectification transistor is increased to increase the on-resistance of the synchronous rectification transistor.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a circuit diagram of a synchronous flyback power conversion circuit in accordance with an embodiment of the present invention;

FIG. 2 is a waveform diagram of a driving circuit in accordance with an embodiment of the present invention;

FIG. 3 is a circuit diagram of a driving circuit in accordance with another embodiment of the present invention;

FIG. 4 is a waveform diagram of a driving circuit in accordance with another embodiment of the present invention;

FIG. 5 is a circuit diagram of a driving circuit in accordance with another embodiment of the present invention; and

FIG. 6 is a flow chart of a driving method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

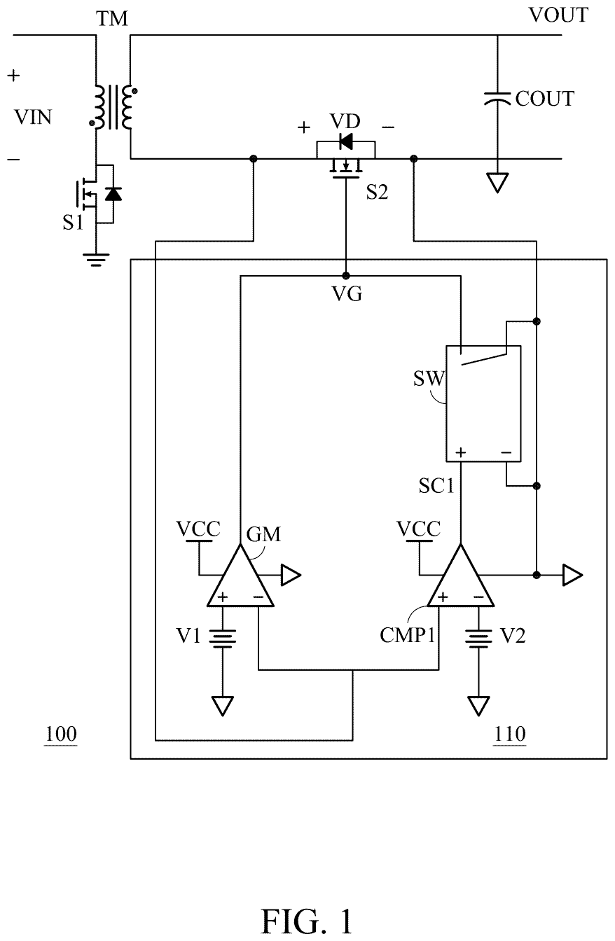

FIG. 1 is a circuit diagram of a synchronous flyback power conversion circuit in accordance with an embodiment of the present invention. As shown in FIG. 1, the synchronous flyback power conversion circuit 100 includes a transformer TM, a first transistor S1, a synchronous rectification transistor S2, an output capacitor COUT, and a driving circuit 110. According to some embodiments of the present invention, the synchronous flyback power conversion circuit is illustrated herein, but not intended to be limited thereto. According to other embodiments of the present invention, the synchronous flyback power conversion circuit may also be replaced by other synchronous power conversion circuits.

According to one embodiment of the present invention, when the first transistor S1 is turned on, the input voltage VIN magnetizes the transformer TM to store energy. According to another embodiment of the present invention, when the first transistor S1 is turned off and the synchronous rectification transistor S2 is turned on, the transformer TM is demagnetized to charge the output capacitor COUT, thereby generating an output voltage VOUT. The driving circuit 110 is configured to control the synchronous rectification transistor S2 to turn on or off.

As shown in FIG. 1, the driving circuit 110 includes a transconductance amplifier GM, a first comparator CMP1, and a driving switch SW. According to some embodiments of the present invention, the transconductance amplifier GM and the first comparator CMP1 are powered by a supply voltage VCC. The transconductance amplifier GM generates a gate voltage VG based on the difference between the first voltage V1 and the drain voltage VD, where the drain voltage VD is the voltage from the drain terminal to the source terminal of the synchronous rectification transistor S2, and the gate voltage VG is the voltage from the gate terminal to the source terminal of the synchronous rectification transistor S2. According to some embodiments of the present invention, the drain voltage VD represents the voltage from the drain terminal to the source terminal of the synchronous rectification transistor S2, and the gate voltage VG represents the voltage from the gate terminal to the source terminal of the synchronous rectification transistor S2.

According to some embodiments of the present invention, the transconductance amplifier GM is configured to adjust the gate voltage VG based on the difference between the drain voltage VD and the first voltage V1 to maintain the on-resistance of the synchronous rectification transistor S2, so that the drain voltage VD is close to the first voltage V1. When the drain voltage VD exceeds the second voltage V2, the first comparator CMP1 enables the first comparison signal SC1 to turn on the drive switch SW, so that the drive switch SW pulls the gate voltage VG down to zero to turn off the synchronous rectification transistor S2. According to some embodiments of the present invention, the first voltage V1 and the second voltage V2 are less than zero. In other words, the first voltage V1 and the second voltage V2 are negative values.

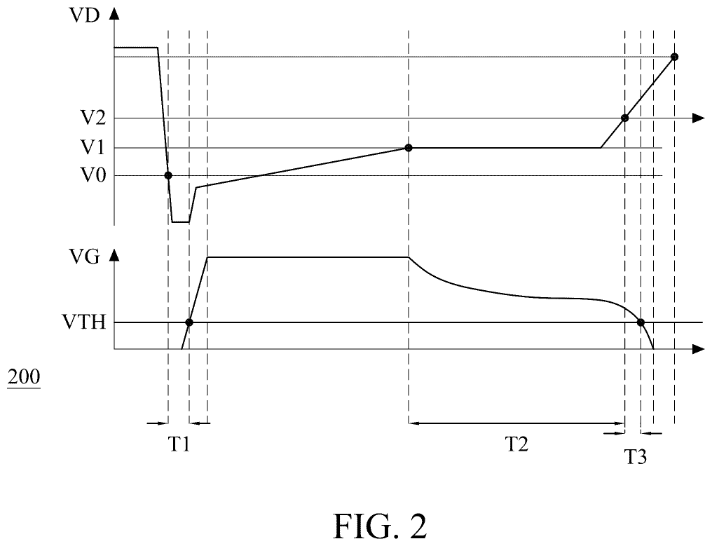

FIG. 2 is a waveform diagram of a driving circuit in accordance with an embodiment of the present invention. The following description of the waveform diagram 200 of FIG. 2 will be combined with the driving circuit 110 of FIG. 1 for detailed description. As shown in FIG. 1, when the transformer TM starts to charge the output capacitor COUT and the synchronous rectification transistor S2 is not turned on, the parasitic diode of the synchronous rectification transistor S2 is turned on first, so that the drain voltage VD drops to a negative voltage. As shown in FIG. 2, when the drain voltage VD is less than the initial voltage V0, the driving circuit 110 turns on the synchronous rectification transistor S2 (not shown in FIG. 1). According to an embodiment of the present invention, the initial voltage V0 is a negative value.

After the first period T1, the gate voltage VG exceeds the threshold voltage VTH of the synchronous rectification transistor S2 to turn on the synchronous rectification transistor S2. In other words, the first period T1 is the turn-on delay time. When the drain voltage VD rises to the first voltage V1, the transconductance amplifier GM is configured to reduce the gate voltage VG to increase the on-resistance of the synchronous rectification transistor S2, so that the drain voltage VD is maintained at the first voltage V1. As shown in FIG. 2, the second period T2 is the period that the transconductance amplifier GM drives the synchronous rectification transistor S2.

As the charging current from the transformer TM to the output capacitor COUT gradually decreases, the drain voltage VD increases. When the first comparator CMP1 determines that the drain voltage VD is not less than the second voltage V2, the first comparator CMP1 controls the drive switch SW to pull the gate voltage VG down to zero. As shown in FIG. 2, when the gate voltage VG is less than the threshold voltage VTH of the synchronous rectification transistor SW, the synchronous rectification transistor S2 is turned off. The third period T3 is the turn-off delay time of the synchronous rectification transistor S2.

According to some embodiments of the present invention, since the gate voltage VG of the synchronous rectification transistor S2 has gradually decreased within the second period T2, the drive switch SW needs to remove less charge when turning off the synchronous rectification transistor S2, thereby achieving the effect of quickly turning off the synchronous rectification transistor S2. That is, the third period T3 is shortened. However, the synchronous rectification transistor S2 is controlled by the transconductance amplifier GM during the second period T2, and therefore has a stability problem. In order to simplify the complexity of the design, it is necessary to optimize the driving circuit 110.

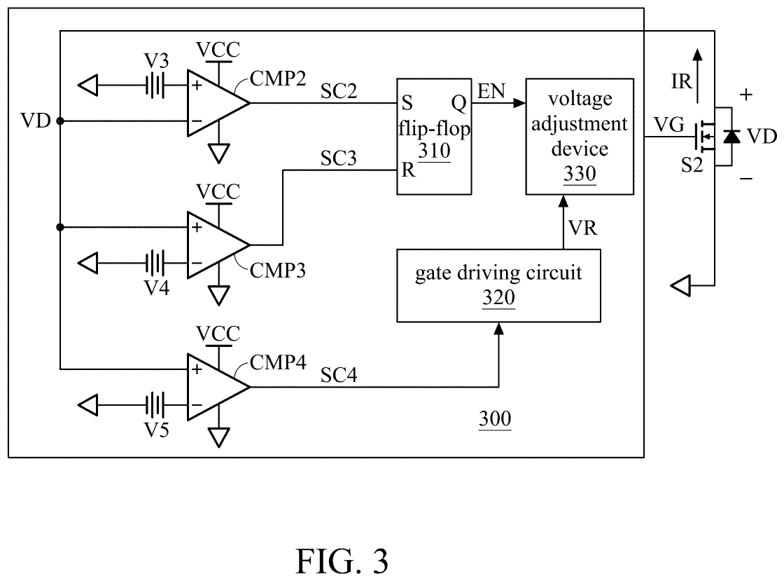

FIG. 3 is a circuit diagram of a driving circuit in accordance with another embodiment of the present invention. As shown in FIG. 3, the driving circuit 300 is configured to drive the synchronous rectification transistor S2, where the synchronous rectification transistor S2 corresponds to the synchronous rectification transistor S2 of FIG. 1. The driving circuit 300 includes a second comparator CMP2, a third comparator CMP3, a fourth comparator CMP4, a flip-flop 310, a voltage adjustment device 320, and a gate driving circuit 330.

The second comparator CMP2 compares the third voltage V3 with the drain voltage VD of the synchronous rectification transistor S2 to generate a second comparison signal SC2. According to one embodiment of the present invention, when the drain voltage VD is less than the third voltage V3, the second comparator CMP2 enables the second comparison signal SC2. According to another embodiment of the present invention, when the drain voltage VD is not less than the third voltage V3, the second comparator CMP2 disables the second comparison signal SC2.

The third comparator CMP3 compares the drain voltage VD of the synchronous rectification transistor S2 with the fourth voltage V4 to generate the third comparison signal SC3. According to an embodiment of the present invention, when the drain voltage VD is not less than the fourth voltage V4, the third comparator CMP3 enables the third comparison signal SC3. According to another embodiment of the present invention, when the drain voltage VD is less than the fourth voltage V4, the third comparator CMP3 disables the third comparison signal SC3.

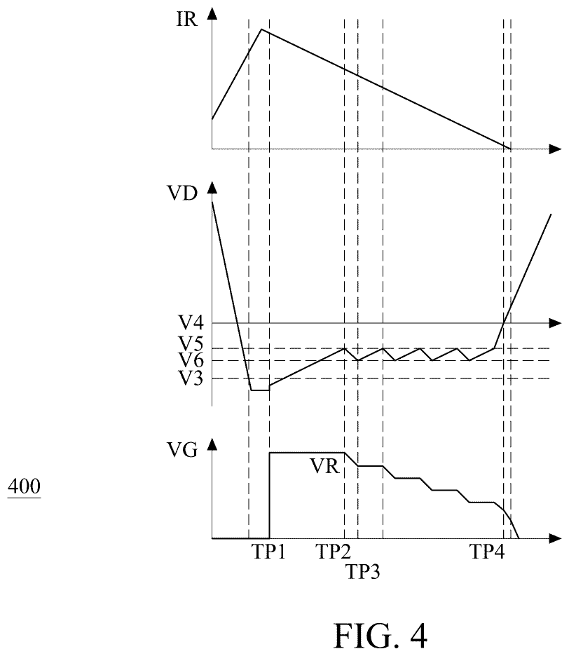

The fourth comparator CMP4 compares the drain voltage VD of the synchronous rectification transistor S2 with the fifth voltage V5 to generate the fourth comparison signal SC4. According to an embodiment of the present invention, when the drain voltage VD is not less than the fifth voltage V5, the fourth comparator CMP4 enables the fourth comparison signal SC4. According to some embodiments of the present invention, the fourth comparator CMP4 has a hysteresis function and a sixth voltage V6 (not shown in FIG. 3, see FIG. 4), so that when the drain voltage VD is less than the sixth voltage V6, the fourth comparator CMP4 disables the fourth comparison signal SC4, where the sixth voltage V6 is less than the fifth voltage V5.

The flip-flop 310 includes a setting terminal S, a reset terminal R, and an output terminal Q, where the setting terminal S receives the first comparison signal SC1, the reset terminal R receives the second comparison signal CMP2, and the output terminal Q outputs the enable signal EN. According to an embodiment of the present invention, when the drain voltage VD is less than the third voltage V3 and the second comparator CMP2 enables the second comparison signal SC2, the flip-flop 310 enables the enable signal EN. According to another embodiment of the present invention, when the drain voltage VD is not less than the fourth voltage V4 and the third comparator CMP3 enables the third comparison signal SC3, the flip-flop 310 disables the enable signal EN.

The voltage adjustment device 320 generates an adjustment voltage VR based on the fourth comparison signal SC4. The gate driving circuit 330 generates a gate voltage VG based on the enable signal EN and the adjustment voltage VR. According to some embodiments of the present invention, the third voltage V3, the fourth voltage V4, the fifth voltage V5, and the sixth voltage V6 are negative values.

FIG. 4 is a waveform diagram of a driving circuit in accordance with another embodiment of the present invention. The following description of the waveform diagram 400 of FIG. 4 will be combined with the synchronous flyback power conversion circuit 100 of FIG. 1 and the driving circuit 300 of FIG. 3 for detailed description.

As shown in FIG. 4, when the transformer TM starts charging the output capacitor COUT, and the synchronous rectification transistor S2 is turned off, the parasitic diode of the synchronous rectification transistor S2 is turned on, causing the rectification current IR to continue to increase and the drain voltage VD to continue to decrease. When the second comparator CMP2 determines that the drain voltage VD is less than the third voltage V3, the flip-flop 310 enables the enable signal EN.

The gate driving circuit 330 turns on the synchronous rectification transistor S2 at the first time point TP1 based on the enable signal EN. According to some embodiments of the present invention, when the gate driving circuit 330 turns on the synchronous rectification transistor S2 at the first time point TP1, the synchronous rectification transistor S2 is fully turned on. In other words, the gate voltage VG at the first time point TP1 is the maximum value of the adjustment voltage VR.

Between the first time point TP1 and the second time point TP2, the drain voltage VD gradually increases and approaches zero due to the gradual decrease of the rectification current IR. At the second time point TP2, the fourth comparator CMP4 determines that the drain voltage VD is not less than the fifth voltage V5 to enable the fourth comparison signal SC4. The voltage adjustment device 320 reduces the adjustment voltage VR based on the fourth comparison signal SC4 being enabled. The gate driving circuit 330 outputs the reduced adjustment voltage VR as the gate voltage VG.

At the third time point TP3, the fourth comparator CMP4 determines that the drain voltage VD is less than the sixth voltage V6 to disable the fourth comparison signal SC4. The voltage adjustment device 320 maintains the adjustment voltage VR based on the fourth comparison signal SC4 being disabled. According to some embodiments of the present invention, the driving circuit 300 is configured to control the drain voltage VD between the fifth voltage V5 and the sixth voltage V6.

At the fourth time point TP4, the third comparator CMP3 determines that the drain voltage VD is not less than the fourth voltage V4 to enable the third comparison signal SC3. The flip-flop 310 disables the enable signal EN based on the third comparison signal SC3 being enabled. The gate driving circuit 330 pulls the gate voltage VG down to zero based on the enable signal EN being disabled, thereby turning off the synchronous rectification transistor S2.

According to some embodiments of the present invention, since the second comparison signal SC2, the third comparison signal SC3, and the fourth comparison signal SC4 are digital signals and the gate driving circuit 330 controls the gate voltage VG based on the digital signals, the stability problem may not be considered during the design process of the driving circuit 300, thereby reducing the complexity of the driving circuit 300.

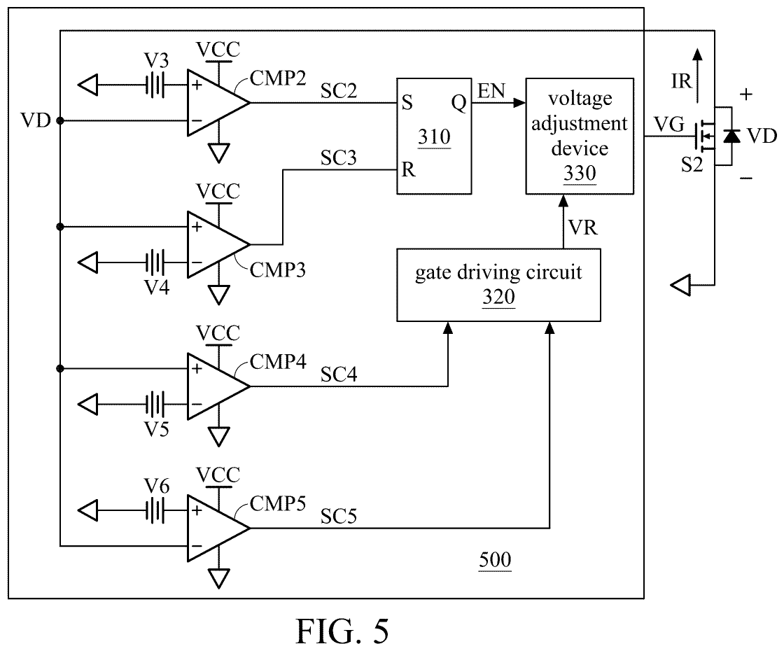

FIG. 5 is a circuit diagram of a driving circuit in accordance with another embodiment of the present invention. Compared to the driving circuit 300 in FIG. 3, the driving circuit 500 in FIG. 5 further includes a fifth comparator CMP5, and the fourth comparator CMP4 of the driving circuit 500 does not have hysteresis.

According to one embodiment of the present invention, when the drain voltage VD is not less than the fifth voltage V5, the fourth comparator CMP4 enables the fourth comparison signal SC4. According to another embodiment of the present invention, when the drain voltage VD is less than the fifth voltage V5, the fourth comparator CMP4 disables the fourth comparison signal SC4.

The fifth comparator CMP5 compares the sixth voltage V6 with the drain voltage VD of the synchronous rectification transistor S2 to generate a fifth comparison signal SC5. According to an embodiment of the present invention, when the drain voltage VD is less than the sixth voltage V6, the fifth comparator CMP5 enables the fifth comparison signal SC5. According to another embodiment of the present invention, when the drain voltage VD is not less than the sixth voltage V6, the fifth comparator CMP5 disables the fifth comparison signal SC5.

The voltage adjustment device 320 generates the adjustment voltage VR based on the fourth comparison signal SC4 and the fifth comparison signal SC5. The detailed operation of the driving circuit 500 will be described in detail in conjunction with FIG. 4.

At the second time point TP2, the fourth comparator CMP4 determines that the drain voltage VD is not less than the fifth voltage V5 to enable the fourth comparison signal

SC4. The voltage adjustment device 320 reduces the adjustment voltage VR based on the fourth comparison signal SC4 being enabled. At the third time point TP3, the fifth comparator CMP5 determines that the drain voltage VD is less than the sixth voltage V6 to enable the fifth comparison signal SC5. The voltage adjustment device 320 maintains the adjustment voltage VR based on the fifth comparison signal SC5 being enabled.

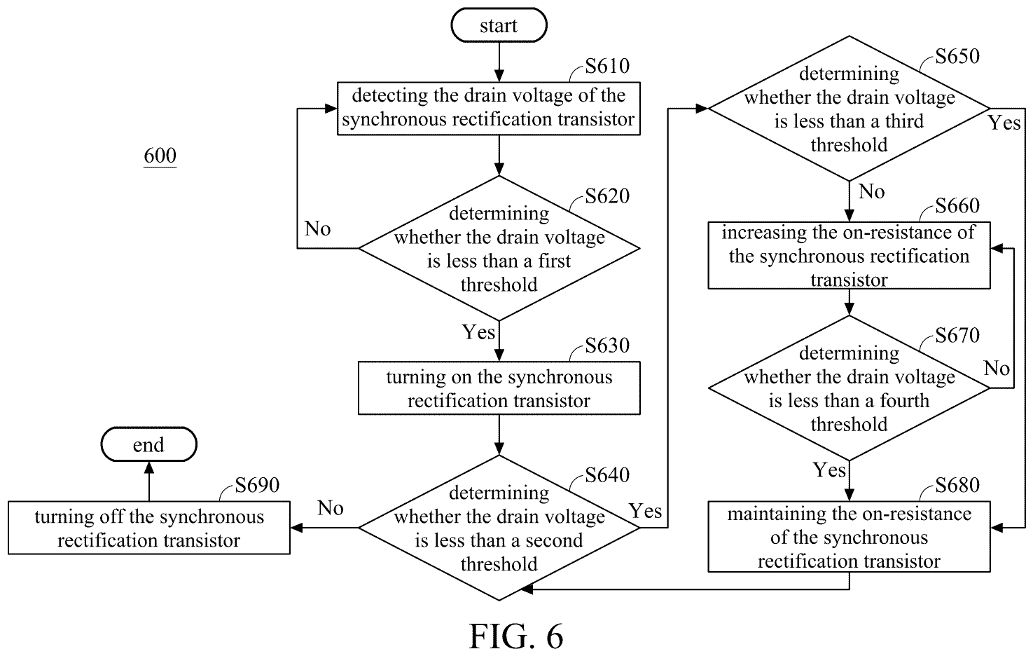

FIG. 6 is a flow chart of a driving method in accordance with an embodiment of the present invention. The following description of the driving method 600 will be combined with the waveform diagram of FIG. 4 for detailed description.

First, the drain voltage VD of the synchronous rectification transistor S2 is detected (Step S610). According to an embodiment of the present invention, as shown in FIGS. 3 and 5, the drain voltage VD is the voltage from the drain terminal to the source terminal of the synchronous rectification transistor S2. Next, it is determined whether the drain voltage VD is lower than the first threshold (Step S620).

As shown in FIG. 4, Step S620 is configured to determine whether the drain voltage VD is lower than the third voltage V3. According to some embodiments of the present invention, when the transformer TM starts charging the output capacitor COUT and the synchronous rectification transistor S2 is still turned off, the parasitic diode of the synchronous rectification transistor S2 is turned on to generate the rectification current IR of FIGS. 3 and 5. In other words, the first threshold corresponds to the third voltage V3 of FIG. 4.

When it is determined in Step S620 that the drain voltage VD is less than the first threshold (i.e., the third voltage V3 of FIG. 4), the synchronous rectification transistor S2 is turned on (Step S630). When it is determined in Step S620 that the drain voltage VD is not less than the first threshold (i.e., the third voltage V3 of FIG. 4), Step S610 is re-executed to continuously detect the drain voltage VD.

After the synchronous rectification transistor S2 is turned on in Step S630, it is determined whether the drain voltage VD is less than the second threshold (Step S640). When it is determined in Step S640 that the drain voltage VD is not less than the second threshold, the synchronous rectification transistor S2 is turned off (Step S690), and the driving method 600 ends. When it is determined in Step S640 that the drain voltage VD is less than the second threshold, it is determined whether the drain voltage VD is less than the third threshold (Step S650).

As shown in FIG. 4, Step S640 is configured to determine whether the drain voltage VD is less than the fourth voltage V4. According to some embodiments of the present invention, when the drain voltage VD is not less than the fourth voltage V4, it means that the rectifier current IR drops to a very low level, so that the drain voltage VD approaches zero. Therefore, when the Step S640 is determined to be negative, the synchronous rectification transistor S2 is turned off. In other words, the second threshold corresponds to the fourth voltage V4 of FIG. 4.

In addition, Step S650 is configured to determine whether the drain voltage VD is less than the fifth voltage V5. In other words, the third threshold corresponds to the fifth voltage V5 of FIG. 4. When Step S650 determines that the drain voltage VD is not less than the third threshold (i.e., the fifth voltage V5), the on-resistance of the synchronous rectification transistor S2 is increased (Step S660). In the embodiment of FIGS. 3-5, the synchronous rectification transistor S2 is an N-type transistor, and reducing the gate voltage VG can increase the on-resistance of the synchronous rectification transistor S2.

According to other embodiments of the present invention, the synchronous rectification transistor S2 may be a P-type transistor, where the source terminal of the synchronous rectification transistor S2 is coupled to the transformer TM, and the drain terminal of the synchronous rectification transistor S2 is coupled to the output voltage VOUT. In addition, increasing the gate voltage VG may increase the on-resistance of the P-type synchronous rectification transistor S2. In other words, regardless of whether the synchronous rectification transistor S2 is an N-type transistor or a P-type transistor, reducing the voltage between the gate terminal and the source terminal of the synchronous rectification transistor S2 helps to increase the on-resistance of the synchronous rectification transistor S2.

After Step S660, it is determined whether the drain voltage VD is less than the fourth threshold (Step S670). As shown in FIG. 4, it is determined whether the drain voltage VD is less than the sixth voltage V6. In other words, the fourth threshold corresponds to the sixth voltage V6 in FIG. 4. When it is determined in Step S670 that the drain voltage VD is not less than the fourth threshold (i.e., the sixth voltage V6), Step S660 is re-executed to continue to increase the on-resistance of the synchronous rectification transistor S2. When it is determined in Step S670 that the drain voltage VD is less than the fourth threshold (i.e., the sixth voltage V6), the on-resistance of the synchronous rectification transistor S2 is maintained (Step S680).

Returning to Step S650, when it is determined that the drain voltage VD is less than the third threshold (i.e., the fifth voltage V5), Step S680 is executed to maintain the on-resistance of the synchronous rectification transistor S2. According to some embodiments of the present invention, maintaining the on-resistance of the synchronous rectification transistor S2 is equivalent to maintaining the voltage value of the gate voltage VG. After Step S680, Step S640 is re-executed to determine whether the drain voltage VD is less than the second threshold.

According to some embodiments of the present invention, after Step S630, Step S640 or Step S650 may be executed. In the embodiment of FIG. 6, Step S640 is executed after Step S630 for explanation, but not intended to be limited thereto.

The present invention proposes a driving circuit and a driving method capable of quickly turning off a synchronous rectification transistor, using a plurality of comparators to determine the voltage between the drain terminal and the source terminal of the synchronous rectification transistor, thereby gradually reducing the voltage between the gate terminal and the source terminal of the synchronous rectification transistor to reduce the charge required to be removed when turning off the synchronous rectification transistor. In addition, by using multiple comparators to gradually reduce the voltage between the gate terminal and the source terminal of the synchronous rectification transistor, there is no need to consider the stability problem, which significantly reduces the design complexity.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A driving circuit for driving a synchronous rectification transistor, comprising:
a first comparator, wherein when a voltage of a drain terminal of the synchronous rectification transistor is less than a first threshold, the first comparator enables a first comparison signal;
a second comparator, wherein when the voltage of the drain terminal of the synchronous rectification transistor is not less than a second threshold, the second comparator enables a second comparison signal;
a third comparator, wherein when the voltage of the drain terminal of the synchronous rectification transistor is not less than a third threshold, the third comparator enables a third comparison signal; and
a gate driving circuit, providing a gate voltage to a gate terminal of the synchronous rectification transistor based on the first comparison signal, the second comparison signal, and the third comparison signal;
wherein the gate driving circuit turns on the synchronous rectification transistor based on the first comparison signal being enabled;
wherein the gate driving circuit turns off the synchronous rectification transistor based on the second comparison signal being enabled;
wherein the gate driving circuit increases on-resistance of the synchronous rectification transistor based on the third comparison signal being enabled.

2. The driving circuit as claimed in claim 1, further comprising:
a flip-flop, comprising a setting terminal, a reset terminal, and an output terminal;
wherein the setting terminal receives the first comparison signal, the reset terminal receives the second comparison signal, and the output terminal outputs an enable signal;
wherein the gate driving circuit further turns on or off the synchronous transistor based on the enable signal.

3. The driving circuit as claimed in claim 1, wherein the first threshold, the second threshold, and the third threshold are less than zero.

4. The driving circuit as claimed in claim 3, wherein the second threshold exceeds the third threshold;
wherein the third threshold exceeds the first threshold.

5. The driving circuit as claimed in claim 1, further comprising:
a voltage adjustment device, adjusting the gate voltage based on the third comparison signal;
wherein the gate driving circuit provides the gate voltage to the gate terminal, so as to increase the on-resistance of the synchronous rectification transistor.

6. The driving circuit as claimed in claim 5, wherein when the voltage of the drain terminal is less than a fourth threshold, the third comparator disables the third comparison signal.

7. The driving circuit as claimed in claim 6, wherein the voltage adjustment device decreases the gate voltage based on the third comparison signal being enabled;
wherein the voltage adjustment device maintains the gate voltage based on the third comparison signal being disabled.

8. The driving circuit as claimed in claim 5, further comprising:
a fourth comparator, wherein when the voltage of the drain terminal is less than a fourth threshold, the fourth comparator enables a fourth comparison signal.

9. The driving circuit as claimed in claim 8, wherein the voltage adjustment device decreases the gate voltage based on the third comparison signal being enabled;
wherein the voltage adjustment device maintains the gate voltage based on the fourth comparison signal being enabled.

10. The driving circuit as claimed in claim 8, wherein the fourth threshold is less than zero;
wherein the third threshold exceeds the fourth threshold;
wherein the fourth threshold exceeds the first threshold.

11. The driving circuit as claimed in claim 1, wherein the synchronous rectification transistor is an N-type transistor;
wherein the gate voltage is decreased to increase the on-resistance of the synchronous rectification transistor.

12. The driving circuit as claimed in claim 1, wherein the synchronous rectification transistor is a P-type transistor;
wherein the gate voltage is increased to increase the on-resistance of the synchronous rectification transistor.

13. The driving circuit as claimed in claim 1, wherein the synchronous rectification transistor is adapted to a synchronous flyback power conversion circuit.

14. A driving method driving a synchronous rectification transistor, wherein the driving method comprises:
detecting a drain voltage from a drain terminal to a source terminal of the synchronous rectification transistor;
determining whether the drain voltage is less than a first threshold;
when the drain voltage is less than the first threshold, turning on the synchronous rectification transistor;
when the synchronous rectification transistor is turned on, determining whether the drain voltage is less a second threshold;
when the drain voltage is not less than the second threshold, turning off the synchronous rectification transistor;
when the synchronous rectification transistor is turned on, determining whether the drain voltage is less than a third threshold; and
when the drain voltage is not less than a third threshold, increasing on-resistance of the synchronous rectification transistor.

15. The driving method as claimed in claim 14, wherein the first threshold, the second threshold, and the third threshold are each less than zero.

16. The driving method as claimed in claim 14, wherein the second threshold exceeds the third threshold;
wherein the third threshold exceeds the first threshold.

17. The driving method as claimed in claim 14, wherein the driving method further comprises:
after the step of increasing the on-resistance of the synchronous rectification transistor, determining whether the drain voltage is less than a fourth voltage; and
when the drain voltage is less than the fourth threshold, maintaining the on-resistance of the synchronous rectification transistor.

18. The driving method as claimed in claim 17, wherein the fourth threshold is less than zero;
wherein the third threshold exceeds the fourth threshold;
wherein the fourth threshold exceeds the first threshold.

19. The driving method as claimed in claim 14, wherein the synchronous rectification transistor is an N-type transistor;
wherein a gate voltage provided to a gate terminal of the synchronous rectification transistor is decreased to increase the on-resistance of the synchronous rectification transistor.

20. The driving method as claimed in claim 14, wherein the synchronous rectification transistor is a P-type transistor;
wherein a gate voltage provided to a gate terminal of the synchronous rectification transistor is increased to increase the on-resistance of the synchronous rectification transistor.
